(19) United States
(12) Patent Application Publication
(10) Pub. No.: US 2009/0230769 A1
(43) Pub. Date: Sep. 17, 2009

(54) METHOD OF BALANCING POWER CONSUMPTION BETWEEN LOADS

(75) Inventor: Steven Aerts, Oud-Heverlee (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/304,771

(22) PCT Filed: Jun. 12, 2007
(86) PCT No.: PCT/IB07/52215

§ 371 Date: Dec. 15, 2008

(30) Foreign Application Priority Data
Jun. 15, 2006 (EP) 06115529.7

(51) Int. Cl. H02J 1/14

(52) U.S. Cl. 307/32

(57) ABSTRACT

There is provided a method of balancing power consumption between a first load and at least one second load, wherein the first load and the at least one second load are connected to a power supply, and wherein the method comprises the step of determining deviations in an actual output voltage with respect to a desired voltage of the power supply, wherein the deviations are due to a change of the magnitude of any of the at least one second load. The method further comprises the step of regulating the first load until the actual output voltage corresponds to the desired voltage for a compensation of the change of the magnitude. The first load is preferably due to a processor. The first load of the processor is thus adjusted in order to compensate for the change of the second load. Preferably, the processor load is adapted by an adaptation of the processor's clock frequency. The method in accordance with the invention is particularly advantageous as the processor itself is a consumer of the apparatus and hence no energy is wasted for load compensation as no extra component is required that is only used for load compensation.

### FIELD OF THE INVENTION

The invention relates to a method of balancing power consumption between loads in general and to a method of balancing power consumption between loads whereof one load is due to a processor in particular. In other aspects the invention relates to an electronic apparatus and to a computer program product that comprises instructions for performing the method in accordance with the invention.

### BACKGROUND OF THE INVENTION

DC power supplies are commonly used to supply electronic circuits such as integrated electronic circuits with electrical power. A battery is an example of such a DC power supply. Real world DC power supplies are non-ideal power supplies. Variations of the loads that are exerted by the components served by the power supply cause deviations on the output voltage due to the non-ideality of the power source. These deviations are also referred to as ripples. Such ripples can cause interference in analogue circuits which might result in performance degradation or even in a malfunction or a breakdown of the system. Therefore, voltage regulators and/or DC/DC converters are used to reduce ripples in the output voltage of the power supply. These circuits dissipate energy for example by the voltage drop of the voltage regulators or by the conversion inefficiency of the DC/DC converters and require active or passive components that do not fulfill other functions in the circuits. The usage of other active or passive components for load regulation and for reducing deviations in the output voltage is however not desirable within highly integrated and low power electronic apparatuses such as in portable/variable, battery operated devices as for example hearing aids since as much energy as possible should be saved for an extension of the battery's lifetime.

WO2005/125012 describes a circuit arrangement and method for controlling the power supply in an integrated circuit, wherein at least one working parameter of at least one electrically isolated circuit region is monitored and the conductivity of a variable resister means is locally controlled so as to individually adjust power supply for each of the at least two electrically isolated circuit regions based on the at least one monitored working parameter. A disadvantage of the method as proposed by the document cited above is that an extra, variable resistor is required whose resistance is adapted in order to compensate any changes in the power supply. Especially in low power systems the resistor wastes a relatively large amount of energy which leads to a degradation of the power supply's lifetime.

There is therefore a need for an improved method of balancing power consumption between loads, a need for an improved electronic apparatus for balancing power consumption and the need for a computer program product that comprises instructions for performing the method of balancing the power consumption between loads.

### SUMMARY OF THE INVENTION

In accordance with an embodiment of the invention, there is provided a method of balancing power consumption between a first load and at least one second load, wherein the first load and the at least one second load are connected to a power supply, and wherein the method comprises the step of determining deviations in an actual output voltage with respect to a desired voltage of the power supply, wherein the deviations are due to a change of the magnitude of any of the at least one second load. The method further comprises the step of regulating the first load until the actual output voltage corresponds to the desired voltage for a compensation of the change of the magnitude.

The regulation of the first load is based on a preceding determination of a deviation in the actual output voltage with respect to the desired voltage of the power supply. The magnitude of the first load is thus changed so that the deviations in the actual output voltage that are caused by a change of any other load are compensated. The first load is exerted by a first device on the power supply. The first device usually fulfills a certain function in the electronic system that comprises the first and the at least one second load. Thus load balancing is performed by adapting the first load of a first device in response to the change of the magnitude of another load. No extra component is required that is only used in order to compensate for any changes in any load. Thus there is no energy wasted.

In accordance with an embodiment of the invention, the method further comprises the step of regulating an auxiliary load if the first load is regulated to its limit, wherein the auxiliary load is only switched on and only takes energy from the power supply when it is used for regulation. The first load which is due to a first device can only be regulated within a certain range. When the full range of regulation of the first load is already employed, then an auxiliary load is used for further regulation in order to fully compensate and suppress the deviations in the actual output voltage. This is particularly advantageous as though energy is wasted large changes of the second load can be compensated which might not be compensated fully by only regulating the first load.

In accordance with an embodiment of the invention, the first load is regulated if the deviations of the actual output voltage exceed a given first threshold value or undershoot a given second threshold value. The desired voltage will never be reached exactly. Thus there will always be small fluctuations on the actual output voltage with respect to the desired voltage. A first threshold value and a second threshold value can be set in order to define a range within deviations of the actual output voltage do not lead to a regulation of the first load in order to compensate for any changes of the second load. Actually these fluctuations within which the first threshold value and the second threshold value might not even arise from a change of the at least second load. Only when the deviations exceed the range set around the desired output voltage by the first threshold value and the second threshold value, a regulation of the first load is initiated.

In accordance with an embodiment of the invention, the actual voltage of the power supply is monitored over time and the deviations are detected when the actual output voltage deviates from the desired voltage. The actual output voltage of the power supply is therefore measured and the deviations are determined from a comparison of the actual output voltage with the desired voltage.

In accordance with an embodiment of the invention, the output voltage is converted by an A/D converter into the digital domain and the deviations are detected by comparing the digitalized instantaneous output voltage with the desired voltage.

In accordance with an embodiment of the invention, the desired voltage is given by the average value of the output voltages. As mentioned above, the power supply can be a battery that degrades. Thus the output voltage will slightly decrease with increasing lifetime of the battery. It is therefore advantageous to determine the average output voltage of the battery and use the average output voltage as the desired voltage. The desired voltage can alternatively be set by a circuit designer. This is particularly advantageous when the circuit is powered by a DC-power supply that does not degrade. An example for such a power supply is an AC/DC transformer.

In accordance with an embodiment of the invention, the deviations are fed into a control loop which regulates the first load and optionally the auxiliary load until the actual output voltage corresponds to the desired voltage.

In accordance with an embodiment of the invention, the first load is due to a processor, wherein the processor instruction execution is controlled by a reference signal, wherein the reference signal is controlled by an output signal of a noise shaper, wherein the input signal of the noise shaper is controlled by the control loop. The noise shaper is a well known device. The input signal of a noise shaper is usually a digital value that is within the input range of the noise shaper. The over-sampled output signal, at least on average over time, reflects the input signal with fewer bits.

The 1-bit output signal of a 1-bit noise shaper can be used to enable and hold the processor instruction execution or, alternatively, to gate (enable and hold) the processor clock signal, which determines the processor execution frequency. As a result, the effective processor execution frequency becomes smaller. A change of the processor's clock frequency causes a change of the load of the processor. Thus, by proper choice of the input signal of the noise shaper, the noise shaper generates an output signal by which the processor clock signal can be controlled and adjusted. As an effect, the load of the processor changes in a way so that changes of the other loads can be compensated.

With a multi-bit noise shaper, the output signal can be used to control the processor execution frequency, e.g. by selecting a processor clock signal between a multiple of reference clock signals having distinct frequencies, or by dividing or multiplying a single reference clock signal by a variable factor which is responsive to changes of the output signal of the noise shaper.

In accordance with an embodiment of the invention, the processor load is changeable via a change of the input signal of the noise shaper, wherein the control loop adapts the input signal of the noise shaper so that the actual output voltage of the power supply corresponds to the desired voltage. The output signal can be adjusted via the input signal. The processor load can therefore be regulated by a change of the input signal as the processor load is adjustable via the processor's execution frequency. The control loop can then determine the appropriate input signal in response to the detection of a deviation and regulate the processor load accordingly.

In accordance with an embodiment of the invention, the deviations of the output voltage show a periodic pattern. The deviation might be caused by load changes that occur periodically.

In accordance with an embodiment of the invention, a periodic sequence of time slots is provided, wherein each time slot of said sequence of time slots has a configurable length, wherein the period of the sequence of time slots is equal to the period of the pattern of the deviations, wherein said sequence of time slots is synchronized with said periodic pattern, wherein a digital representation is generated from a measurement of the actual output voltage by use of a delta sigma modulator, and wherein for each time slot an average deviation or an average voltage is determined.

In accordance with an embodiment of the invention, the deviations of the average output voltage with respect to the average output voltage are determined for each time slot. The actual output voltage or alternatively the deviations can be used as an input signal of a delta sigma modulator. The delta sigma modulator generates a digital representation which corresponds to a 1-bit bitstream. The digital representation reflects the input signal. The digital representation can be detected for example by counting the logical “1”-bits in the various time slot. Thus, a digital representation of the average deviation or of the average output voltage during each time slot is determined.

In accordance with an embodiment of the invention, a time slot specific load compensation value is determined for each time slot by use of the corresponding average deviation or by use of the average voltage. The time slot specific load compensation values correspond to the amount by which the processor load has to be changed from time slot to time slot in order to compensate for any changes in the at least one second load. As the average deviations are determined by use of the delta sigma modulator for each time slot, the control loop can determine the time slot specific load compensation values which corresponds to the amount by which the processor has to be changed at the beginning of the corresponding time slot.

In accordance with an embodiment of the invention, the time slot specific load compensation values are determined by a control loop, wherein the control loop determines for each time slot specific load compensation value a time slot specific input signal for a noise shaper, wherein the input signal is provided to the input of the noise shaper during the corresponding time slot, wherein the corresponding output signal of the noise shaper is used control and to regulate the processor execution frequency.

In accordance with an embodiment of the invention, the deviations are determined by use of a model.

In another aspect the invention relates to an electronic apparatus for balancing power consumption between a first load and at least one second load, said first load and said at least one second load are connected to a power supply, wherein the electronic apparatus comprises means for determining deviations in an actual output voltage with respect to a desired voltage of the power supply, wherein the deviations are due to a change of the magnitude of any of the at least one second load. The electronic apparatus further comprises means for regulating the first load until the actual output voltage corresponds to the desired voltage for a compensation of the change of the magnitude.

In accordance with an embodiment of the invention, the first load is due to a processor, wherein the first load is controllable via a change of the processor clock frequency.

In another aspect the invention relates to a computer program product for balancing power consumption between the first load and at least one second load.

These and other aspects of the invention will become even more apparent from and elucidated with reference to the embodiments described hereinafter.

### BRIEF DESCRIPTION OF THE DRAWINGS

In the following preferred embodiments of the invention will be described in greater detail by way of example only making reference to the drawings in which:

FIG. 1 shows a block diagram of an electronic apparatus,

FIG. 2 depicts a flow diagram showing the basic steps performed by the method in accordance with the invention,

FIG. 3 shows a block diagram of an electronic apparatus,

FIG. 4 shows a block diagram of an electronic apparatus,

FIG. 5 shows a block diagram of an electronic apparatus,

FIG. 6 illustrates means that are employed for load control based on a power model, and

FIG. 7 shows block diagrams of two electronic apparatuses which are used for adapting the clock frequency of a processor.

### DETAILS OF THE PREFERRED EMBODIMENTS

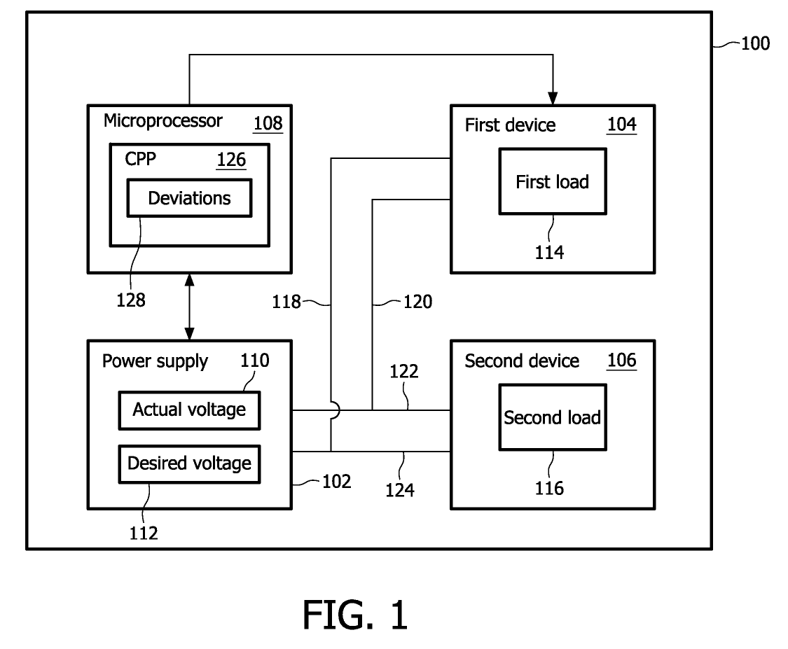

FIG. 1 shows a block diagram of an electronic apparatus 100. The electronic apparatus 100 comprises a power supply 102, a first device 104, a second device 106, and a microprocessor 108. The power supply 102 provides an actual voltage 110 via electrical connections 118 and 120 to the first device 104 which exerts a first load 114 on the power supply 102. The power supply 102 provides the actual output voltage 110 via electrical connections 122 and 124 to the second device 106 which exerts a second load 116 on the power supply. In the example described here, the first device 104 and the second device 106 are connected in parallel to the power supply 102. The scope of the invention shall however not be restricted to that kind of arrangement as the method in accordance with the invention is also employable in the case of the first device 104 and the second device 106 being connected in series.

The microprocessor 108 executes a computer program product 126 which is for example loaded from a memory not shown in FIG. 1 during or after the startup of the electronic apparatus 100. The computer program product 126 is able to monitor the actual output voltage 110 of the power supply 102 and is further able to control and to adjust the first load 114 of the first device 104.

In operation, the computer program product 126 determines deviations 128 in the actual output voltage of the power supply. These deviations 128 are due to a change of the magnitude of the second load 116. In order to compensate for these deviations, the first load 114 is adapted until the actual output voltage 110 corresponds to the desired voltage 112. The deviations 128 in the output voltage of the power supply 102 are caused by load variations and are also referred to as ripples. These ripples can be understood as undesired AC-components in the DC output signal of the power supply. The method in accordance with the invention is particularly advantageous as it allows to compensate the ripples caused by a change of the magnitude of the second load 116 by adjusting the magnitude of the first load 114 so that no extra load which would waste energy has to be employed.

The microprocessor 108 can be, as depicted in FIG. 1, a separate unit of the electronic apparatus 100. In preferred embodiments of the invention, the first device 104 itself is a microprocessor. Hence, the computer program product 126 can be directly executed by the first device 104. Various embodiments of the control loop for determining the deviations in the voltage supply and for further regulating/adjusting the first load 114 in response to a change of the second load 116 are described in detail in the subsequent figures.

Needless to say that the method in accordance with the invention is not only limited to two loads as depicted in FIG. 1. In general, there is a plurality of loads provided with energy from the power supply 102. The first load 114 is adapted accordingly whenever a load of the plurality of the loads changes in a way so that voltage deviations in the actual output voltage of the power supply are induced.

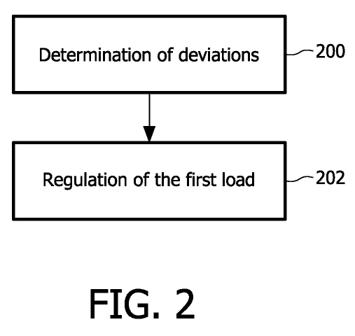

FIG. 2 shows a flow diagram of the basic steps that are performed by the method in accordance with the invention. In step 200 deviations in the actual output voltage with respect to the desired voltage of the power supply are determined. In step 202 the first load is regulated until the actual output voltage corresponds to the desired voltage in order to compensate a change of the magnitude of any of the at least one second load that has caused the deviations.

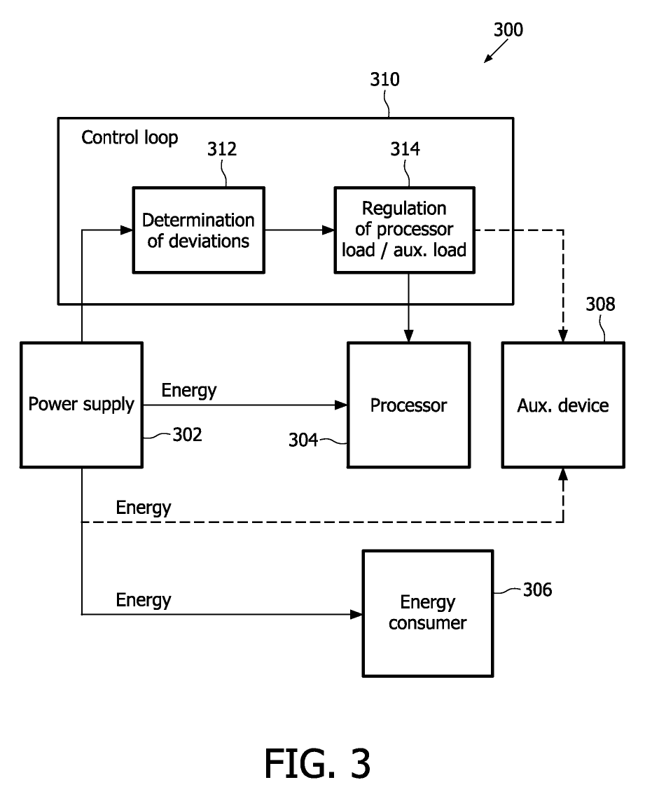

FIG. 3 shows a block diagram of an electronic apparatus 300. The electronic apparatus 300 comprises a DC-power supply 302 such as a battery, a processor 304, an energy consumer 306, an auxiliary device 308, and a control loop 310. The power supply 302 provides electric energy to the processor 304 and the energy consumer 306. The auxiliary device 308 can be switched on/off via the control loop 310. Consequently, it only draws electric energy from the power supply 302 when it is switched on. The processor 304, the energy consumer 306 as well as the auxiliary device 308 exert loads on the power supply 302. A change of the load of the energy consumer 306 causes deviations on the desired output voltage of the power supply 302.

The control loop 310 performs in essence the steps of determining the deviations in the actual output voltage as given by the first function of the control loop 312 and of regulating the processor load or the load of the auxiliary device as given by the second function of the control loop 314.

The deviations as determined by the first function of the control loop 312 can be classified into two major classes. Deviations of the first class are deviations that are due to occasional or instantaneous changes of the load exerted by the energy consumer 306. Deviations of the second class are deviations that are due to periodic changes of the load of the energy consumer 306.

In the following, the determination of the first class of deviations/ripples in the output voltage by the control loop 310 is addressed. The actual output voltage of the power supply 302 is monitored. It is furthermore detected when the actual output voltage exceeds a given upper or lower threshold with respect to the desired voltage. The threshold can be defined according to allowable ripple tolerances and the desired voltage can correspond to the average output voltage. The voltage deviations can be measured by tracking the supply voltage continuously using a general purpose A/D converter. The average output voltage (the desired output voltage) can then be calculated in the digital domain or by a computer program and the deviations can be determined by a comparison between the actual output voltage that exceeds the given margins relative to the average voltage.

Alternatively, an analogue circuit that comprises a comparator can be used for detecting the actual output voltage. The actual output voltage can then be compared by use of the comparator with the average output voltage. The output of the comparator indicates thus whether the supply voltage is above, within, or below the given margins that are set by the upper and lower threshold relative to the average voltage.

The second function of the control loop 314, that is employed for a regulation and adjustment of the load of the processor 304 and optionally of the auxiliary device 308 can be implemented by a software component that uses the measured and digitalized deviations as follows. Load compensation is instantaneously decreased when the supply voltage exceeds the lowest threshold until it is within the margins set by the first and the second threshold value. Load compensation is instantaneously increased when the supply voltage exceeds the lowest threshold. When the deviations are within the margins, then the load compensation can be slowly adjusted so that the actual voltages corresponds to the desired voltage.

As mentioned before, the load of the processor 304 can be regulated by adjusting the processor's clock frequency. The range in which the processor load can be controlled is however bound by:

minimum load/frequency determined by real/time processing requirements, and

maximum operating frequency of the processor.

The minimum load/frequency can be determined statically at design time or dynamically based on calculated processor activity. A distinction can be made between time/critical processing versus background processing. If the boundaries of the processor is reached, the auxiliary device 308 is activated by the control loop 310. The auxiliary device 308 exerts as mentioned above an extra load. The auxiliary device 308 can for example be implemented as a current DAC, comprising a cascade of current drains that can be enabled individually. The current consumption of each drain increases by a power of 2 such that the total current drain (load) is proportional to the applied binary value.

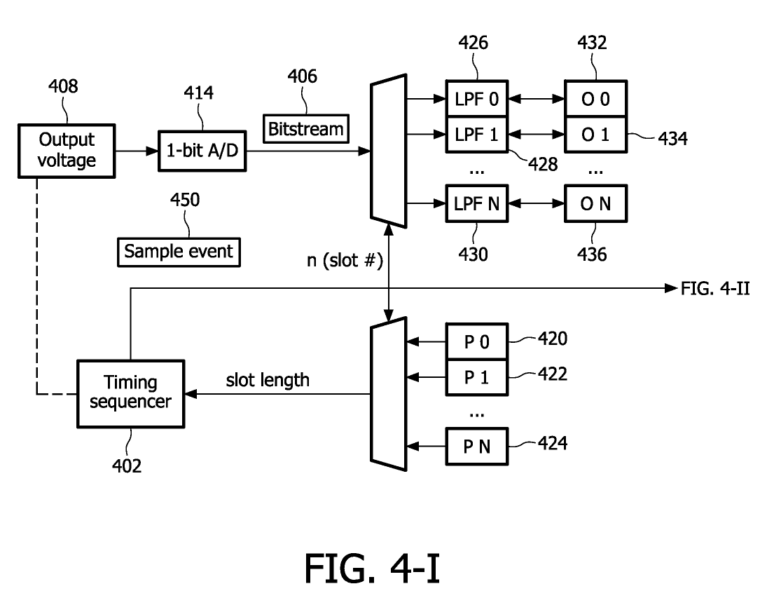

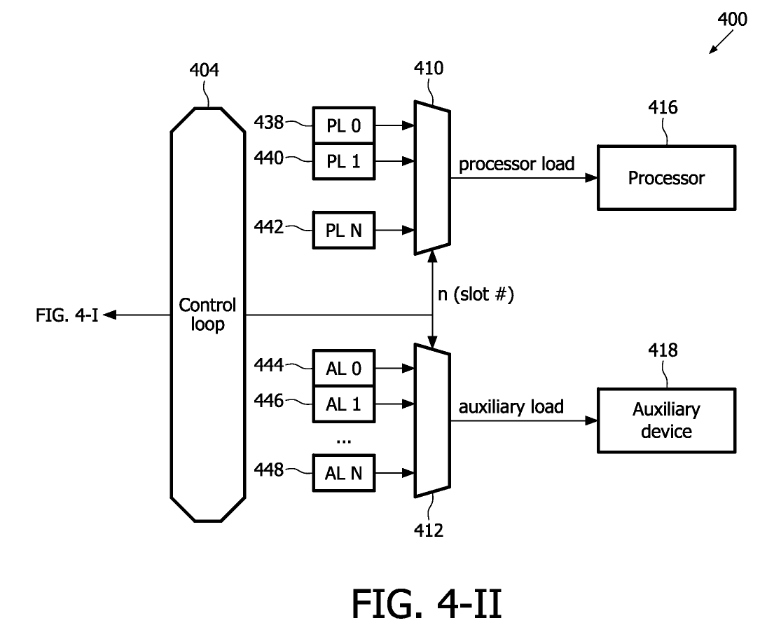

In the following, the determination of the second class of deviations/ripples in the output voltage is discussed. As mentioned before, the second class of deviations is caused by periodic load variations and hence, the deviations themselves show a periodic pattern when monitored over time. FIG. 4 shows a block diagram of an electronic apparatus that can be used (and that replaces the control loop 310 in FIG. 3) in order to determine deviations in the output voltage, to adjust the load of the processor, and, if required, also the load of the auxiliary device.

The electronic apparatus 400 comprises a timing sequencer 402, a 1 bit A/D converter 414, a control loop 404, registers 410 and 412 and a plurality of low pass filters comprising LPF₀ 426, LPF₁ 428, . . . , LPFₙ 430.

The timing sequencer 402 is synchronized with the periodic variations of the output voltage 408 of the power supply. The timing sequencer 402 provides (N+1) programmable registers P₀ 420, P₁ 422, . . . , and Pₙ 424. The registers of the timing sequencer 402 constitute a periodic sequence of time slots, whereby each time slot corresponds to one register and whereby each time slot has a configurable and predefined length. The number of time slots and the length of each time slots can for example be determined by a designer of the electronic apparatus 400. The period of the sequence of time slots corresponds to the period of the variations of the output voltage 408 as the timing sequencer is synchronized by the periodic output voltage 408. The registers of the timing sequencer 402 are processed one by one. At the end of each register, a sample event 450 is produced that is used to trigger the control loop 404 and hence the adaptation of a processor 416 and an auxiliary device 412.

The 1 bit A/D converter 414 is a Sigma Delta converter. It receives a measure of the output voltage 408 of the power supply and converts it into a 1 bit-bitstream 406. The bitstream 406 is dispatched on a per time slot basis to low pass filters LPF₀ 426, LPF₁ 428, . . . , and LPFₙ 430. The resulting outputs of the low pass filters correspond to the average voltages of the output voltage 408 during the corresponding time slot. Each average voltage O₀ 432, O₁ 434, . . . , Oₙ 436 represents a digitalization of the average output voltage of the output voltage 408 within the corresponding time interval as given by the time slots P₀ to Pₙ. The average voltages O₀ 432, O₁ 434, . . . , Oₙ 436 are used by the control loop 404 in order to determine the required processor load compensation values PL₀ 438, PL₁ 440, . . . , and PLₙ 442. Control loop 404 furthermore determines the required compensation values AL₀ 444, AL₁ 446, . . . , and ALₙ 448 for the auxiliary device 418 on a per slot basis. If the load compensation can be fully carried out only by adjusting the processor load, then the load compensation values for the auxiliary load in the corresponding time slot would be set to 0. The processor load compensation values PL₀ 438, PL₁ 440, . . . , and PLₙ 442, and the compensation values AL₀ 444, AL₁ 446, . . . , and ALₙ 448 can be stored and updated on the registers 410 and 412. The load compensation values relate to the values by which the loads of the processor 416 and of the auxiliary device 418 have to be changed during the corresponding time slot in order to compensate for a change of another load. Furthermore, the load compensation values are distributed to the processor 416 and to the auxiliary device 418.

In an alternative embodiment, the A/D converter 414 receives directly the deviations of the actual output voltage with respect to the average voltage. The bitstream 406 is then dispatched and further processed as described above. The average voltages O₀ 432, O₁ 434, . . . , Oₙ 436 refer then to the average deviations with respect to average power supply voltage. The control loop can then determine the required compensation values for the processor 416 and for the auxiliary device 418 on the basis of the average deviations.

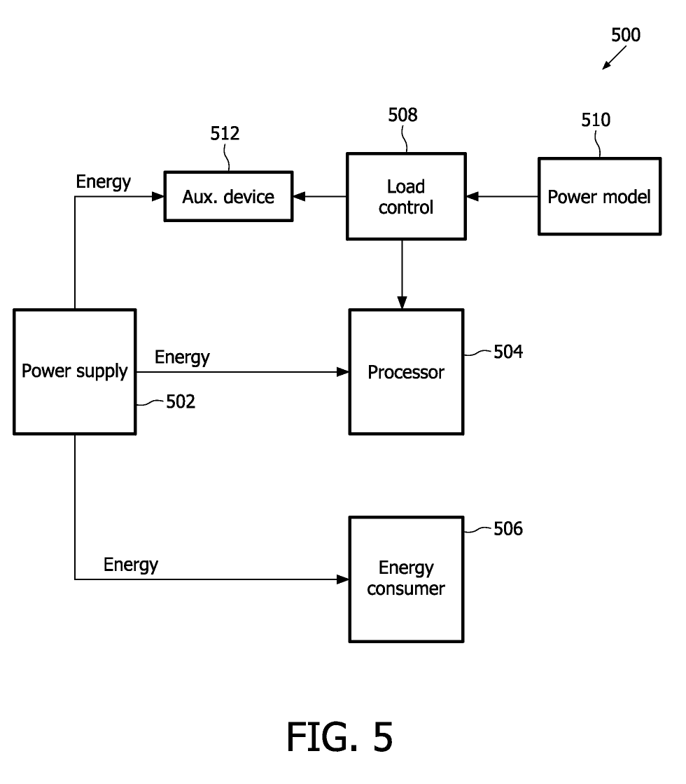

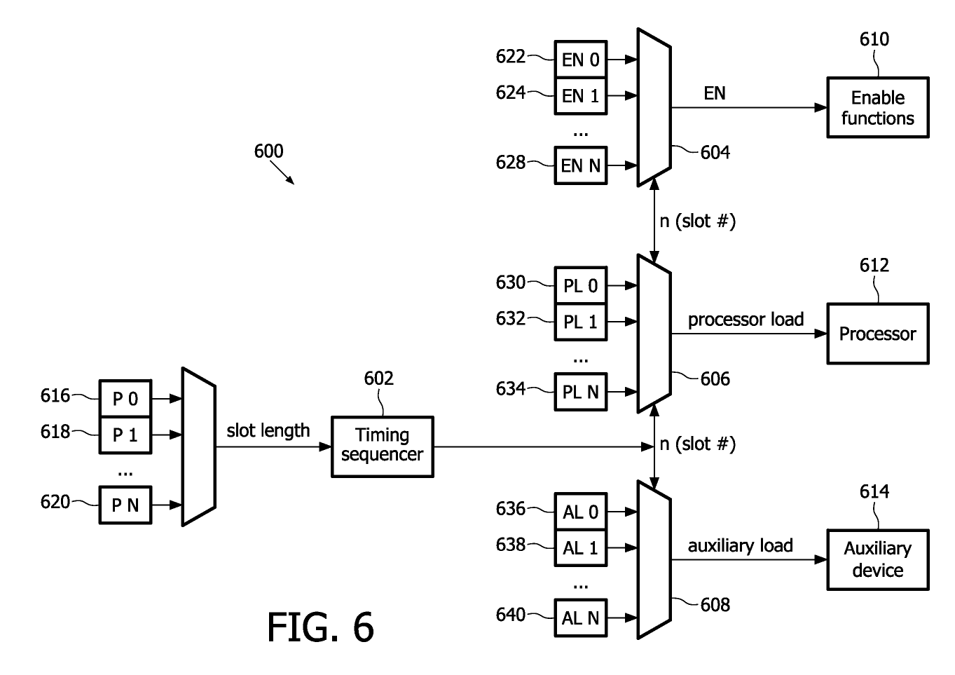

FIG. 5 shows a block diagram of an electronic apparatus 500. The electronic apparatus 500 comprises a power supply 502, a processor 504, and an energy consumer 506. The electronic apparatus furthermore comprises means 508 for controlling the load of the processor 504. The processor load is controlled in order to compensate any deviations in the output of the power supply that are due to changes of the load of the energy consumer 506. The load of the energy consumer 506 is known to be deterministic and predictable. Feed-forward control of the processor 504 (and of an auxiliary device not shown in FIG. 5) can be applied using a supply load estimation power model 510. The simplest implementation of such a power model 510 comprises a mapping of features to the required additional power when enabling the feature. FIG. 6 shows a block diagram of an electronic apparatus 600 which is employed for balancing the load of a processor 612 and an auxiliary device 614, whereby the load balancing is based on a power model. The electronic apparatus further comprises a timing sequencer 602 and register 604, 606, and 608.

Consider a system with periodic activation of a set of enabling functions 610 which comprises functions EN₀ 622, EN₁ 624, . . . , ENₙ 628 as given by the register 604. The activation of a function is triggered by a corresponding time slot P₀ 616, P₁ 618, . . . , and Pₙ 620 as given by the timing sequencer 602. During each time slot, a different set of functions EN₀ 622, EN₁ 624, . . . , ENₙ 628 is therefore enabled by the register 604. The additional power when enabling these functions can be determined or measured. The additional power can then be used to determine the load variations that have to be applied to the processor 612 in order to compensate for the additional power drawn from the voltage supply. The so determined values for the required load compensation can then be distributed among the processor load compensation values PL₀ 630, PL₁ 632, . . . , PLₙ 634 and the auxiliary load values AL₀ 636, AL₁ 638, . . . , ALₙ 640. Thus, the load compensation values can be stored in the corresponding registers 606 and 608 and the values can be applied to the processor 612 and correspondingly to the auxiliary device 614 during the corresponding time slots.

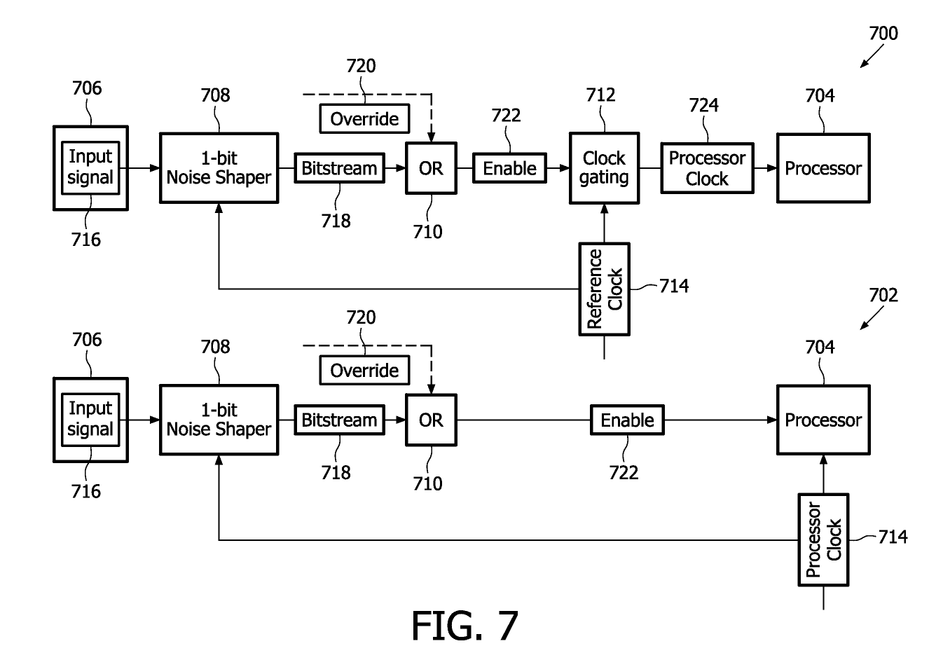

FIG. 7 shows block diagrams of two electronic apparatuses 700 and 702. The two apparatuses 700 and 702 are used for adapting the clock frequency of a processor 704. Each apparatus 700 and 702 comprises the processor 704, a signal generator 706, a 1-bit noise shaper 708, a logical override gate 710, and a reference clock 714. The apparatus 700 furthermore comprises a clock gating controller 712.

As has been mentioned before, the control loop (not shown in FIG. 7) is used to determine load compensation values which are used to change the load of the processor. Each load compensation values can relate to an input signal 706 that is produced by the signal generator which is controllable by the control loop. The input signal 706 is used as an input of the noise shaper which is running on a reference frequency delivered by the reference clock 714. The output signal of the noise shaper is a bitstream 718. The bitstream 718 is used as an input of the logical override gate 710.

The logical override gate 710 is used in order to override the bitstream by an override signal 720 if required. The processor 704 can for example be part of a processor subsystem which comprises other components such as memories and peripherals. The components can be interconnected by means of a processor bus having a processor bus clock, which is for performance reasons preferably characterized by a constant frequency that is equal to the reference frequency as provided by the reference clock 714. It is desirable that the control of the processor execution frequency via the bitstream 718 can be temporarily disabled by use of the override signal 720 during interactions of the processor with one or more of the other components in such a processor subsystem.

The logical override 710 produces an enabling signal 722 as an output. When the logical override 720 is zero, the enabling signal 722 corresponds to the bitstream 718.

In apparatus 700, the clock gating component uses the enabling signal 722 to gate the reference frequency as provided by the reference clock 714, whereby a signal 724 for clocking the processor 704 is generated.

In apparatus 702, the enabling signal 722 is used to enable and to hold the instruction execution of the processor 704.

The processor load changes when the execution frequency of the processor changes. The execution frequency can be varied via the input signal of the noise shaper, which is controlled by the control loop. Thus, the apparatuses 702 and 704 allow the control of the processor load in a very simple and efficient manner.

The invention described herein relates to a method of balancing power consumption between a first load and at least a second load of an electronic apparatus, wherein the first load is preferably due to a processor. The deviations of the actual output voltage with respect to a desired output voltage of a power supply providing electric power to the loads are determined. The deviations refer to changes in the magnitude of the at least one second load. The first load of the processor is adjusted in order to compensate for the change of the second load. Preferably, the processor load is adapted by an adaptation of the processor's clock frequency. The method in accordance with the invention is particularly advantageous as the processor itself is a consumer of the apparatus and hence no energy is wasted for load compensation as no extra component is required that is only used for load compensation.

In the subsequent claims, reference signs have been incorporated in order to facilitate an understanding of the claims. Any reference sign shall however not be construed as limiting the scope.

### LIST OF REFERENCE NUMERALS

Electronic apparatus
Power supply
First device
Second device
Microprocessor
Actual voltage
Desired voltage
First load
Second load
Electrical connection
Electrical connection
Electrical connection
Electrical connection
Computer program product
Deviations
Electronic apparatus
Power supply
Processor
Energy consumer
Auxiliary device
Control loop
First function of control loop
Second function of control loop
Electronic apparatus
Timing sequencer
Control loop
Bitstream
Output voltage
Register
Register
A/D converter
Processor
Auxiliary device
Time slot
Time slot
Time slot
Low pass filter
Low pass filter
Low pass filter
Average value during time slot
Average value during time slot
Average value during time slot
Processor load
Processor load
Processor load
Auxiliary load
Auxiliary load
Auxiliary load
Sample event
Power supply
Processor
Energy consumer
Control loop
Power model
Auxiliary device
Electronic apparatus
Timing sequencer
Register
Register
Register
Set of enabling functions
Processor
Auxiliary device
Time slot
Time slot
Time slot
Function
Function
Function
Processor load
Processor load
Processor load
Auxiliary load
Auxiliary load
Auxiliary load
Electronic apparatus
Electronic apparatus
Processor
Signal generator
Noise shaper
Logical override
Clock gating component
Reference clock
Input signal
Bitstream
Override signal
Enabling signal
Signal

1. A method of balancing power consumption between a first load (114) and at least one second load (116) in an electronic circuit, said first load and said at least one second load being connected to a power supply (102) supplying an actual output voltage to the electronic circuit, said method comprising:
determining deviations (128) in the actual output voltage (110) of said power supply with respect to a desired voltage (112), said deviations being due to a change of the magnitude of any of said at least one second load (116); and
regulating said first load (114) until the actual output voltage of the power supply corresponds to said desired voltage (112) for a compensation of said change of the magnitude.

2. The method of claim 1, wherein said first load (114) is due to a processor, wherein said first load is regulated by regulating the execution frequency of said processor.

3. The method of claim 1, wherein said first load is regulated if said deviations of the actual output voltage exceed a given first threshold value or undershoot a given second threshold value.

4. The method of claim 3, wherein the actual output voltage (110) of said power supply (102) is monitored over time, and wherein said deviations (128) are detected when the actual output voltage (110) deviates from the desired voltage (112).

5. The method of claim 4, wherein said output voltage (110) is converted by an A/D converter into the digital domain, and wherein said deviations (128) are detected by comparing the digitalized instantaneous output voltage with said desired value.

6. The method of claim 1, wherein said desired value is given by the average value of the output voltages measured over a given period of time.

7. The method of claim 1, wherein said deviations are fed in a control loop, wherein said control loop regulates said first load until the actual output voltage corresponds to said desired voltage.

8. The method of claim 1, wherein said first load is due to a processor (704), wherein the execution frequency of said processor is provided by a reference signal, wherein the reference signal is enabled and held or gated by an output signal (718) of a noise shaper, wherein the input signal (716) of said noise shaper (708) is controlled by said control loop.

9. The method of claim 8, wherein the processor load is changeable via a change of said input signal (716), wherein said control loop adapts the input signal of said noise shaper so that the actual output voltage of the power supply corresponds to the desired voltage.

10. The method of claim 1, wherein the deviations of the output voltage show a periodic pattern.

11. The method of claim 10, wherein a periodic sequence of time slots (420, 422, 424) is provided, wherein each time slot of said sequence of time slots has a configurable length, wherein the period of the sequence of time slots is equal to the period of the pattern of said deviations, wherein said sequence of time slots is synchronized with said periodic pattern, wherein a digital representation (406) is generated from a measurement of the actual output voltage by use of a delta sigma modulator (414), and wherein for each time slot an average deviation or an average voltage (432, 434, 436) is determined.

12. The method of claim 11, wherein for each time slot (420, 422, 424), a time slot specific load compensation value (438, 440, 442) is determined by use of the corresponding average deviation or of the average voltage, said time slot specific load compensation values (438, 440, 442) corresponding to the amount by which the processor load has to be changed from time slot to time slot in order to compensate for any changes in the at least one second load.

13. The method of claim 12, wherein said time slot specific load compensation values are determined by a control loop, wherein said control loop determines for each time slot specific load compensation value a time slot specific input signal (716) for a noise shaper (708), wherein the input signal is provided to the input of said noise shaper during the corresponding time slot, wherein the corresponding output signal (718) of said noise shaper is used to enable and hold or to gate the processor execution frequency.

14. The method of claim 1, wherein said deviations are determined by use of a model.

15. An electronic apparatus of balancing power consumption between a first load (114) and at least one second load (116) in an electronic circuit, said first load and said at least one second load being connected to a power supply (102) supplying an actual output voltage to the electronic circuit, said electronic apparatus comprising:
means for determining deviations (128) in the actual output voltage (110) with respect to a desired voltage (112) of said power supply (102), said deviations being due to a change of the magnitude of any of said at least one second load; and
means for regulating said first load until the actual output voltage of the power supply corresponds to said desired voltage for a compensation of said change of the magnitude.

16. A computer program, embodied on a computer readable medium, for balancing power consumption between a first load and at least one second load in an electronic circuit, said first load and said at least one second load being connected to a power supply supplying an actual output voltage to the electronic circuit, said computer program including computer executable instructions to perform acts comprising:
determining deviations in the actual output voltage of said power supply with respect to a desired voltage, said deviations being due to a change of the magnitude of any of said at least one second load; and
regulating said first load until the actual output voltage of the power supply corresponds to said desired voltage for a compensation of said change of the magnitude.
